(19) United States
(12) Patent Application Publication
(10) Pub. No.: US 2009/0141909 A1
(43) Pub. Date: Jun. 4, 2009

(54) Microphone Circuit

(76) Inventors: Arthur William van Katz, Victoria (CA); Stephen Webb, Victoria (CA)

Correspondence Address: Mike Powell, 1711 Barrie Road, Victoria, BC, V8N 2W4, omitted

(21) Appl. No.: 12/367,215

(22) Filed: Feb. 6, 2009

Related U.S. Application Data
(63) Continuation-in-part of application No. 11/748,820, filed on May 15, 2007.
(60) Provisional application No. 60/820,217, filed on Jul. 24, 2006.

(51) Int. Cl. H04R 3/00

(52) U.S. Cl. 381/113

(57) ABSTRACT

Microphones are used in acoustically insulated masks, headsets, phones and personal digital assistants. Frequently, the microphone provides an input to speech recognition software. The working environment is often humid and the speaker's mouth is in close proximity to the microphone. Frequently the signal suffers from clipping and distortion caused by the large signals and nonlinear response of the microphone circuitry. The claimed invention uses a resistor connected in parallel with the signal source to reduce its sensitivity and to produce a signal suitable for use with speech recognition software. The resistor can be varied for different speakers.

### CROSS-REFERENCES TO OTHER APPLICATIONS

This application is a continuation in part of U.S. application Ser. No. 11/748,820, filed on May 15, 2007. U.S. application Ser. No. 11/748,820 claims the benefit of U.S. provisional application 60/820,217, filed Jul. 24, 2006.

### FIELD OF INVENTION

This invention relates generally to improving the performance of a signal source when loud sounds cause the signal source to generate large signals. Frequently, this occurs when the signal source is placed within a mask, a headset, a phone or a personal digital assistant to record speech for use with speech recognition software.

### BACKGROUND OF INVENTION

The recognition of speech by software is common. Part of the technology's increased usage is due to the availability of inexpensive hardware for capturing signals generated by microphones. Electret microphones are particularly suitable as they are small (less than 1 cc) and inexpensive (less than $10). Other circuitry (for amplifying, filtering and digitizing the signal) is commonly available off-the-shelf.

Typically, a microphone mounted on a stand or in a headset, is used to record speech as an analog signal. This signal is then amplified, filtered and digitized by hardware and the resulting datastream is analyzed by software. In a personal computer (“PC”) environment, the hardware for amplification, filtering and digitizing is placed either on a card which is installed inside the PC case or in an external adapter which connects to a standard communications port (for example: serial, USB or Firewire).

When a microphone is used in open air, there are two challenges to be overcome: the signal is usually small (a few millivolts) and noisy.

The first problem calls for the signal to be amplified before it is suitable for digitizing. Typically, within the microphone itself, the signal is used to control the current through a field effect transistor (“FET”), thus avoiding drawing any appreciable current directly from the electret. The resulting signal is then amplified by conventional circuitry either in an audio card installed in a PC or by an external adapter connected to a port on a PC.

Secondly, the level of noise in the signal may be sufficiently large that speech recognition is either of very poor quality or not possible at all. The noise originates as background noise from the activities of other people or equipment nearby, (such as computer fans or air conditioning or even the breathing of the speaker). In some situations, it is possible to control the noise by placing the speaker in a closed booth, which is insulated from external noise and suitably constructed to eliminate reflections and resonances within the booth. In other situations, a variety of mechanical or electrical steps can be taken to separately record a noise signal (for example, with a second microphone or during the dead intervals between speech elements) and cancel this from the microphone signal.

In some situations, microphones are not used in open air for speech recognition. The speaker's voice and the microphone must be kept within an insulated enclosure so that the speaker's voice cannot be overheard by others nearby. For example: in a courtroom, a court reporter needs to record the words spoken by those present without interfering with the proceedings; similarly, wherever communications must be secure (e.g. military, police or security forces) or where a mask must be worn for other reasons (e.g. divers, astronauts or pilots). It is desirable that the masks employed be small and light in construction for portability, acoustically insulated to pre-vent the speaker's voice being overheard, and with some ventilation or separate air supply for breathing.

Recording sound within a mask has both benefits as well as disadvantages. On the positive side, the shell and the acoustic insulation used means that the microphone within the mask is insulated from external noise. However, the mounting of the microphone on the mask means that the microphone can pick up vibrations through its mechanical connection to the shell of the mask. Further, the small air space means that the humidity is high and condensation on the electrical components is possible. Lastly, in order to be portable and easily mounted over the mouth, the masks are small. This means that the speaker's mouth is close to the microphone and human speech, particularly plosive sounds (such as “P”, “T” or “K”) or voiced plosives (“B” or “D”) causes large displacement of the electret's membrane and the signals generated are large.

Various mechanical steps can be taken to avoid noise within the mask. For example, the microphone can be mounted in a rubber boot or additional foam can be placed to dampen resonances originating within the mask's hard shell.

Unfortunately, little can be done to eliminate humidity. In practice, considerations of reliability and safe operation dictate that such masks should avoid separate circuit boards or batteries within the mask enclosure. An air vent for breathing is advantageously positioned down-wards and towards the speaker's chest.

U.S. Pat. No. 5,978,491 (Papadopoulos, Nov. 2, 1999) describes circuitry for improving the performance of an electret microphone. Papadopoulos points out that “louder speech, breath ‘pops’ and physical jolts can cause large drain current swings”. In two situations large voltage swings at the gate of the FET within the electret microphone can cause distortion. Firstly, if swings in the gate voltage cause the gate voltage to become positive, the drain current may become extremely high due to forward conduction through the FET. Secondly, if the gate voltage becomes large and negative, the drain current may reach cut-off. In both cases, the signal is clipped and distorted and “speech recognition by computer software is adversely affected”.

Papadopoulos claims a number of circuit arrangements employing resistance, inductance and capacitance to modify the form of the resulting signal. In all cases, the components employed are connected between the bias voltage and the drain terminal of the FET or between the source terminal of the FET and ground (see FIGS. 4, 5 and 6).

Although Papadopoulos claims circuitry that is applicable to both two- and three-terminal electret microphones (claims 7, 8, 20 & 21), the description makes it clear (column 3, lines 1-14) that two-terminal electret microphones must have an externally accessible jumper track which can be removed so that the source terminal of the FET can be used separately from ground.

The applicants' experience shows that electret microphones commonly available from electronic component manufacturers produce distorted and clipped speech when installed within a mask. Although the signals produced are just intelligible to the human ear, they are not suitable for speech recognition by computer software. There appear to be four sources causing distortion of the signal:
(1) The vibrating membranes within an electret are not designed to handle very loud sounds. In extreme cases, the membrane may actually strike the surrounding case, causing clipping of the signal or shorting of the signal to zero. When this occurs, not only is the instantaneous signal affected but the electret itself takes some time before its internal charges return to normal.
(2) As pointed out by Papadopoulos, the FET employed within an electret microphone has limits. In particular if the signal present at the gate reaches cut-off, no current flows through the FET. Alternatively, if the gate voltage becomes positive, a very large current flows through the FET, in some circumstances causing damage to the FET itself. In both cases, the resulting signals are clipped—the “FET clipping problem”.
(3) The electret microphone is inherently a nonlinear device, as is readily apparent from an inspection of the specification curves supplied by the manufacturer (see FIG. 4). However, when operated in the open air, the signals appearing at the gate of the FET are small and any assumption of local linearity is usually accurate. However, with large signals appearing at the gate of the FET, the response is definitely nonlinear. The nonlinearity means that any gain or attenuation provided by the FET is amplitude dependent. This causes a distortion of the signal—the “nonlinearity problem”.
(4) Large signals produced by an electret microphone can exceed the input limits of down-stream devices such as sound cards or USB adapters—the “large output signal problem”. These devices generally take audio signals and amplify and digitize them for use in speech recognition. Signals exceeding 50 mV are frequently a problem.

In summary, it is desirable to be able to modify the operation of signal sources such as electret microphones to avoid clipping and distortion occurring in large signal situations, so that the signals generated are more intelligible to the ear and can be used effectively with speech recognition software. The invention described herein has no effect on the operation of the electret or the size of the signal generated at the gate (problems 1 and 2 above). However, the invention described herein does address the last two of the four problem areas described above—the nonlinearity problem and the large output signal problem.

### SUMMARY OF THE INVENTION

In one embodiment of the invention, a circuit is provided comprising a signal source having a negative pole bearing a negative charge and a grounded pole connected to ground, a field effect transistor (“FET”) having a drain, a gate and a source, wherein the negative pole of the electret is connected to the gate of the FET, a source of DC electric power is connected to drain of the FET and the source of the FET is connected to ground, the invention comprising a resistor connected between the drain and the source of the FET so as to reduce the drain to source voltage and reduce and linearize the sensitivity of the drain to source voltage in response to changes in the gate to source voltage.

In a second embodiment of the invention, the resistor connected between the drain and source of the FET is a potentiometer of variable resistance.

In a third embodiment of the invention, the circuit is mounted within an acoustically insulated mask, a headset, a phone or a personal digital assistant.

A fourth embodiment of the invention comprises the method of connecting the resistor between the drain and the source of the FET.

### BRIEF DESCRIPTION OF THE DRAWINGS

FIG. 1 is an image showing a general perspective view of a typical mask used for recording speech without disturbing the surrounding environment.

FIG. 2 is a diagram showing the electrical connections between the components used in speech recognition by computer software using an electret microphone connected to a PC via USB port.

FIG. 3 is a schematic circuit diagram of a circuit in accordance with the invention.

FIG. 4 is a graph of the drain current passing through a FET against the voltage between drain and source for several values of gate voltage.

FIG. 5 is a graph of the drain current passing through a FET against the gate voltage for several values of the drain to source voltage.

FIG. 6 is a schematic diagram of the circuit of the invention with a generalized signal source

### DETAILED DESCRIPTION

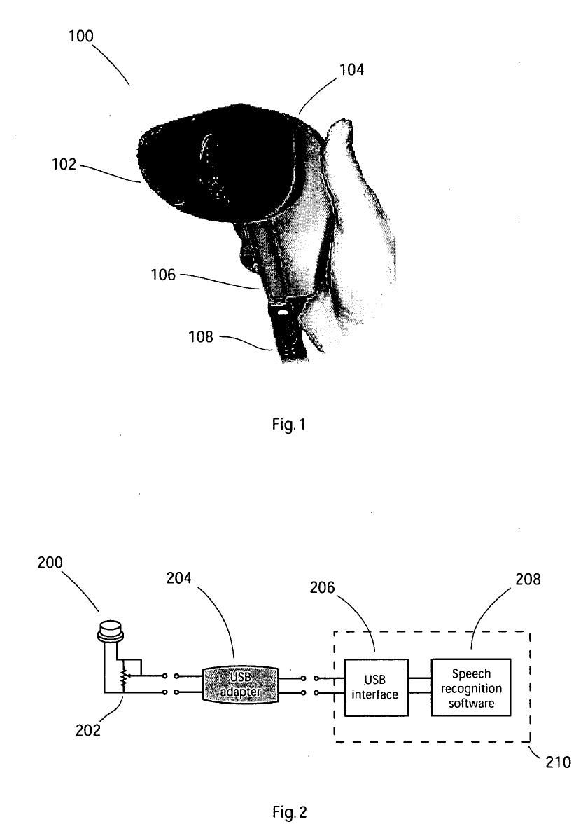

FIG. 1 is an image showing a general perspective view of a typical mask 100 used for recording speech without disturbing the surrounding environment. 102 shows a mouthpiece covering just the mouth. The mouthpiece 102 is made of a soft elastic rubber-like material to provide comfort and a good acoustic seal around the mouth of the speaker. A hard shell 104 forms the body of the mask and is partially filled with insulating foam. 106 shows a ventilation tube to provide an airflow to assist with speech and the partial removal of moisture. An electrical cable 108 is connected to a microphone (not shown) which is installed within the enclosed space of the mask 100.

FIG. 2 shows the electrical connections of the components of the preferred embodiment. A two-terminal electret microphone 200 is shown with a potentiometer 202 connected in parallel between the externally accessible drain and source terminals of the FET (not shown) located within the microphone. The electret microphone 200 is mounted in a mask such as is shown generally as 100 in FIG. 1. The microphone and potentiometer are connected via a USB adapter 204 to a USB port 206 of a PC 210 where computer software 210 converts digitized speech into text.

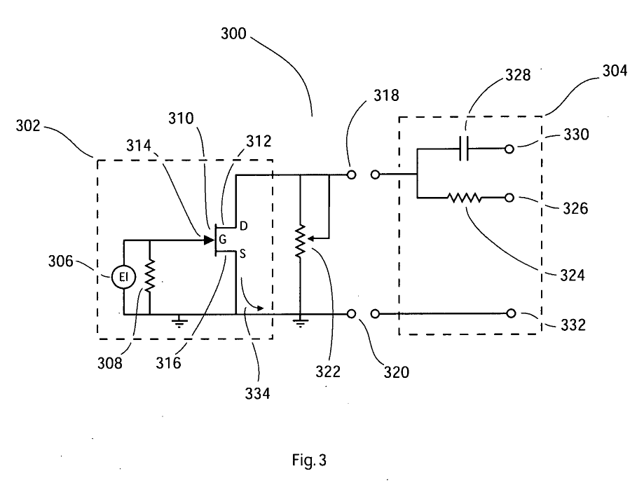

FIG. 3 shows a circuit 300 representing the electrical behaviour of the preferred embodiment of the invention. A two-terminal electret microphone is shown within a dashed box generally as 302. The electret microphone 302 is connected to a USB adapter shown generally within a dashed box as 304 by two externally accessible terminals 318 and 320.

The electret microphone is comprised of an electret 306, one pole of which is connected to the gate 314 of a Field Effect Transistor (“FET”) 310 and the other pole to ground. For proper operation, the electret is connected with negative polarity to the gate 314. Sound energy received at the electret 306 produces voltage fluctuations at the gate 314. The electret appears as a voltage source of very high impedance 308.

The FET 310 is biased by power supplied through a standard USB interface (not shown). This appears in the circuit as a voltage applied to terminal 326 through a source impedance 324 connected in turn to the external terminal 318 which is attached to the drain 312 of the FET 310.

The source 316 of the FET 310 is connected to ground and is externally accessible through terminal 320. This is in turn connected to ground through the USB interface at 332.

The voltage at the gate of the FET 314 controls the current flowing through the FET 310 from drain 312 to source 316. Variations in the gate voltage produce variations in the drain to source current 334. The corresponding voltage changes at 318 are isolated from the DC bias by capacitor 328 and used as the signal input at 330 to the USB adapter.

A variable resistor 322 is connected external to the microphone enclosure in parallel across the FET 310 from drain 318 to source 320.

For convenience the following symbols are used to refer to components in the circuit of FIG. 3:

| | FIG. 3 | |
|---|---|---|
| Symbol | reference(s) | Description |
| V | 326-332 | Total bias voltage. |
| V_{ds} | 318-320 | Voltage between drain and source of the FET. |
| R₁ | 324 | Resistance in series with the bias supply. |
| I_{ds} | 334 | Current from drain to source through the FET. |
| R₂ | 322 | Variable resistance connected in parallel from |
| | | drain to source across the FET. |
| V_{gs} | 314-320 | Gate voltage. |
| V_{gsoff} | | Value of the gate voltage V_{gs} which reduces the |
| | | drain current I_{ds} to zero (i.e. the “pinch off” |
| | | voltage). |
| I_{dss} | | Maximum drain current obtained when the gate |
| | | is shorted to ground, i.e. V_{gs} is zero. |

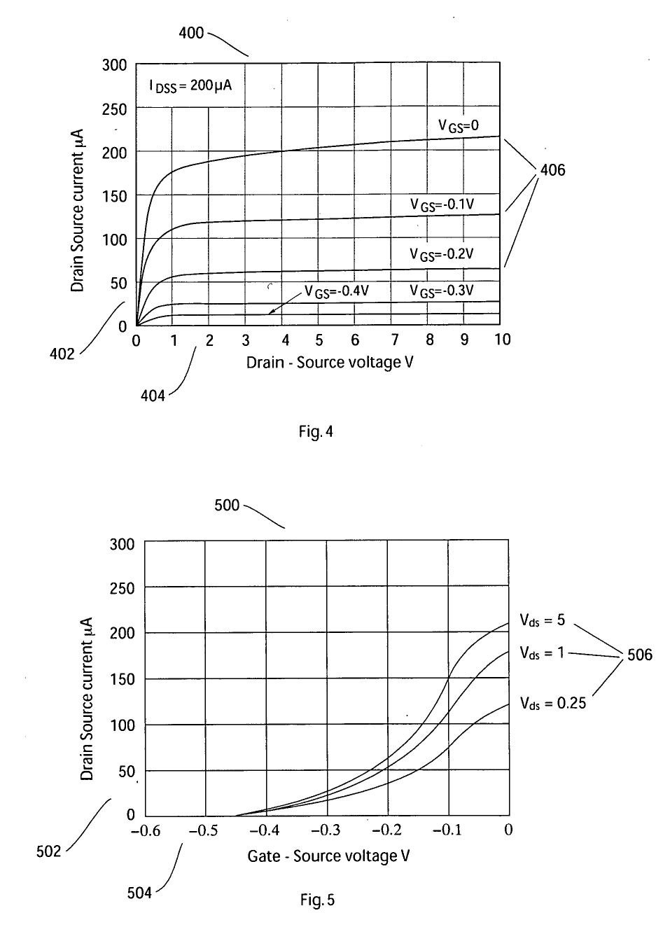

FIG. 4 shows the operation of a typical FET 400. The drain to source current I_{ds} 402 is plotted against the drain to source voltage V_{ds} 404 for a selection of gate voltages V_{gs} 406. In this particular example, the FET is rated for a maximum drain to source current I_{dss} of approximately 200 μA. For purposes of analysis, the FET is considered as having two regions. The first (for values of V_{ds} greater than 1 volt) corresponds to the behaviour of the FET when its channel is saturated; the second (for values of V_{ds} less than one volt) corresponds to the linear region where changes in gate voltage cause a narrowing of the channel width. The saturated region is characterized by an almost flat response to changes in V_{ds} and a significant response to changes in V_{gs}. The linear region shows the drain to source current I_{ds} responding to both V_{ds} and V_{gs} but with smaller swings than for the saturated region.

FIG. 5 500 shows the same data as FIG. 4 but with the drain to source current I_{ds} 502 plotted against gate to source voltage V_{gs} 504 for three different values of drain to source voltage V_{ds} 506. The curves show the least curvature as V_{gs} approaches both zero and the cut-off voltage V_{gsoff}. The greatest curvature (and corresponding most nonlinear response) is seen in the central range of V_{gs} values, −0.1v to −0.3v.

There are two steps that may be taken to alleviate the effects of nonlinearity:
(1) Firstly, the gate voltage V_{gs} can be controlled so that the FET is operated in one of the regions of flatter response, particularly closer to the cut-off point V_{gsoff}. In this region, the response is both closer to linear and of less sensitivity. Regrettably, this is not possible for mass-produced inexpensive electret microphones as the gate terminal of the FET is not accessible. Alternatively, it is possible to operate the FET with lower drain to source voltages V_{ds} as exemplified by the V_{ds}=0.25v curve in FIG. 5. This curve shows a lower overall gradient and exhibits less nonlinearity. One approach to achieve this result is to provide a separate power supply of suitably small voltage. In practice, this could be done by installing a battery in a mask but this has the drawback of degradation by moisture and the battery would have to be replaceable. Further the construction of the mask would be more complex, making acoustic insulation more difficult. A better alternative is to use a standard power source, such as the 5 volt supply from a USB interface delivered through a USB adapter (such as the USBD-2A stereo adapter from Andrea Electronics Corporation) and provide circuitry to reduce V_{ds}.
(2) Secondly, the sensitivity, measured as the rate of change of the drain to source voltage with respect to changes in gate to source voltage

$$\frac{\partial {V}_{ds}}{\partial {V}_{gs}}$$

can be reduced so that the fluctuations in V_{ds} are smaller and the assumptions of local linearity hold.

The large output signal problem can be addressed by reducing the sensitivity

$$\frac{\partial {V}_{ds}}{\partial {V}_{gs}}$$

so that changes in V_{gs} produce smaller changes in V_{ds}.

The following analysis is directed to the circuit of FIG. 3 which is in accordance with the preferred embodiment of the invention. The installation of a resistor between drain and source of an electret microphone is a very simple modification which addresses both the nonlinearity problem and the large output signal problem.

### Operation in the Saturated Region

With reference to FIG. 3, the voltage between drain and source of the FET is related to the total bias voltage by:

$${V}_{ds} = V - {R}_{1} ( {I}_{ds} + \frac{{V}_{ds}}{{R}_{2}} ) \qquad ( 1 )$$

Rearranging the terms of this equation:

$${V}_{ds} = \frac{{R}_{2}}{{R}_{1} + {R}_{2}} ( V - {R}_{1} {I}_{ds} ) \qquad ( 2 )$$

The current from drain to source through the FET is in turn related, to good approximation, to the gate voltage by:

$${I}_{ds} = {{I}_{dss} ( 1 - \frac{{V}_{gs}}{{V}_{gsoff}} )}^{2} \qquad ( 3 )$$

### (“Introductory Electronic Devices and Circuits”, Second Edition, Robert T. Paynter, Prentice Hall, 1991 at p. 426; “Introduction to Electronic Circuit Design” Richard R. Spencer & Mohammed S. Ghausi, Prentice Hall, 2001 at p. 124)

Thus, ignoring the effects of capacitance, the voltage observed between drain and source is:

$${V}_{ds} = \frac{{R}_{2}}{{R}_{1} + {R}_{2}} \{ V - {R}_{1} {{I}_{dss} ( 1 - \frac{{V}_{gs}}{{V}_{gsoff}} )}^{2} \} \qquad ( 4 )$$

and the sensitivity of the drain to source voltage, V_{ds}, with respect to changes in V_{gs} is given by:

$$\frac{\partial {V}_{ds}}{\partial {V}_{gs}} = \frac{2 {R}_{1} {R}_{2} {I}_{dss}}{{V}_{gsoff} ( {R}_{1} + {R}_{2} )} ( 1 - \frac{{V}_{gs}}{{V}_{gsoff}} ) \qquad ( 5 )$$

### Operation in the Linear Region

According to Spencer & Ghausi supra at p. 122, in the linear region of operation of a FET and when V_{ds} is small, the drain current I_{ds} is related to V_{ds} and V_{gs} by:

$${I}_{ds} = {G}_{o} ( 1 - \frac{1}{{X}_{ch}} \sqrt{2 ɛ \frac{( {V}_{o} - {V}_{gs} )}{{qN}_{D} ( 1 + {N}_{D} / {N}_{A} )}} ) {V}_{ds} \qquad ( 6 )$$

where Gₒ, X_{ch}, ε, Vₒ, q, N_{D} and N_{A} are constants related to the materials used.

This can be rewritten as:

I_{ds}=(K₁−K₂\sqrt{Vₒ−V_{gs}})V_{ds} (7)

Now, when the gate voltage reaches cut-off, the current falls to zero. At this voltage:

K₁=K₂\sqrt{Vₒ−V_{gsoff}} (8)

and the expression for I_{ds} becomes:

I_{ds}=K₂{Vₒ−V_{gsoff}−\sqrt{Vₒ^{-V}_{gs}}}V_{ds} (9)

For a KTK₅₉6S FET, V_{gsoff}=−0.45v and we can use the following two sets of values from the I_{ds}−V_{ds} curves of FIG. 4 to estimate the values for K₂ and Vₒ:

V_{gs}=0v, V_{ds}=0.5v, I_{ds}=160 μA

V_{gs}=−0.1V, V_{ds}=0.5v, I_{ds}=90 μA

It turns out that Vₒ is small in comparison to V_{gs} and this leads to a simple calculation for K₂:

$${K}_{2} = \frac{{I}_{ds}}{{V}_{ds} ( \sqrt{- {V}_{gsoff}} - \sqrt{- {V}_{gs}} )} = 500 \times {10}^{- 6} \qquad ( 10 )$$

with a corresponding value for Vₒ of approximately 1.6 mV. Thus, to good approximation (ignoring Vₒ):

I_{ds}=K₂{\sqrt{−V_{gsoff}}−\sqrt{−V_{gs}}}V_{ds} (11)

Combining this equation with equation (1) above, we get the following expression for V_{ds} in terms of V_{gs}:

$${V}_{ds} = \frac{V}{1 + \frac{{R}_{1}}{{R}_{2}} + {R}_{1} {K}_{2} ( \sqrt{- {V}_{gsoff}} - \sqrt{- {V}_{gs}} )} \qquad ( 12 )$$

The corresponding equation for the sensitivity is:

$$\frac{\partial {V}_{ds}}{\partial {V}_{gs}} = \frac{{VR}_{1} {K}_{2}}{2 \sqrt{- {V}_{gs}} {\{ 1 + \frac{{R}_{1}}{{R}_{2}} + {R}_{1} {K}_{2} ( \sqrt{- {V}_{gsoff}} - \sqrt{- {V}_{gs}} ) \}}^{2}} \qquad ( 13 )$$

### The Effect of R₂ on the Drain to Source Voltage and the Sensitivity

The above analysis can be applied to the circuit of FIG. 3 with known values for typical components. For example: For a configuration using an ANM-₅₂₅₄L electret microphone manufactured by Projects Unlimited Inc. with power supplied by a USBD-2A stereo adapter from Andrea Electronics Corporation, the total bias voltage V is 5 volts delivered from a source with impedance R₁ of 2200Ω. The ANM-₅₂₅₄L electret microphone contains a ₅₉6S FET (as typified by the KTL₅₉6S FET from Korea Electronics Corporation) with maximum drain current I_{dss} typically of 200 μA and a gate to source cut-off voltage V_{gsoff} of −0.45 volts. With these values, we can examine the predicted values of drain to source voltage V_{ds} and its associated sensitivity

$$\frac{\partial {V}_{ds}}{\partial {V}_{gs}}$$

to changes in gate to source voltage V_{gs}. The table below shows these values without R₂ (i.e. R2=∞), with two values of R₂ in the saturated region (R₂=2200Ω and 1000Ω) and two values in the linear region (R2=500Ω and 100Ω). The values are calculated using equations (4) and (5) above for R2 greater than or equal to 100Ω and with equations (12) and (13) otherwise.

| | R₂ = ∞ | | R₂ = 2200Ω | | R₂ = 1000Ω | | R₂ = 500Ω | | R₂ = 100Ω | |
|---|---|---|---|---|---|---|---|---|---|---|
| V_{gs} | V_{ds} | $\frac{\partial {V}_{ds}}{\partial {V}_{gs}}$ | V_{ds} | $\frac{\partial {V}_{ds}}{\partial {V}_{gs}}$ | V_{ds} | $\frac{\partial {V}_{ds}}{\partial {V}_{gs}}$ | V_{ds} | $\frac{\partial {V}_{ds}}{\partial {V}_{gs}}$ | V_{ds} | $\frac{\partial {V}_{ds}}{\partial {V}_{gs}}$ |
| −0.1 V | 4.72 V | 1.40 | 2.36 V | 0.70 | 1.48 V | 0.44 | 0.86 V | 0.26 | 0.22 V | 0.016 |
| −0.2 V | 4.84 V | 1.06 | 2.42 V | 0.53 | 1.51 V | 0.33 | 0.89 V | 0.19 | 0.22 V | 0.011 |
| −0.3 V | 4.93 V | 0.70 | 2.47 V | 0.35 | 1.54 V | 0.22 | 0.91 V | 0.16 | 0.22 V | 0.009 |
| −0.4 V | 4.98 V | 0.36 | 2.49 V | 0.18 | 1.56 V | 0.11 | 0.92 V | 0.15 | 0.22 V | 0.008 |

The effect of R2 on the operation of the electret microphone is threefold. Firstly, the drain to source voltage is decreased, forcing the FET to operate in its linear region; secondly the sensitivity

$$\frac{\partial {V}_{ds}}{\partial {V}_{gs}}$$

is reduced; and thirdly, the sensitivity

$$\frac{\partial {V}_{ds}}{\partial {V}_{gs}}$$

becomes closer to constant over the range of V_{gs} values. As discussed above, these three effects all serve to reduce the problems of non-linearity and large output signal.

In practice, the reduction in V_{ds} and the sensitivity

$$\frac{\partial {V}_{ds}}{\partial {V}_{gs}}$$

can be taken too far and the signals become so small that they are swamped by residual noise and become unusable. In the preferred embodiment, the resistor R₂ is a potentiometer which may be varied by the user with a thumbwheel. For speech recognition, the user, as part of the training set-up, varies the potentiometer until the speech recognition software indicates that it can convert the text reliably. An additional benefit of the potentiometer is that the microphone can be tuned for optimal performance by a variety of different speakers.

In testing conducted by the applicants, a dramatic improvement in fidelity was noted with an R2 value of approximately 800Ω. This corresponds to a value of 1.2 volts for V_{ds}, exactly at the shoulder between the linear and saturated regions of the curves shown in FIG. 4.

It is of note that the preferred embodiment of the invention is presented without other circuitry connected to the terminals of the microphone's FET. In practice, other circuitry (for example, as shown in Papdopoulos) is often connected to the terminals of the FET to achieve other effects. These effects certainly alter the frequency response of the microphone but do not disturb the linearizing and desensitizing effects of the invention presented herein. For example, in electret microphones using a three terminal FET, there is frequently a resistor connected between source and ground (Rₛ). When this is present, the analysis presented in equations (1) to (13) remains unaltered but with the value of R₁ now including an additional amount for the resistor Rₛ.

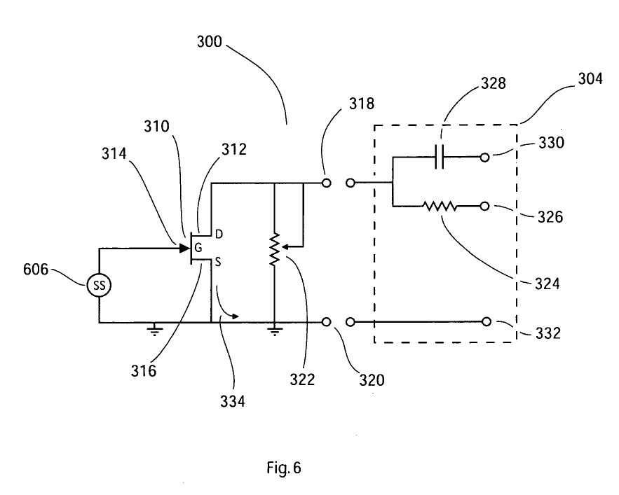

FIG. 6 shows the circuit of the invention 600 employed with a general signal source 606, other than an electret microphone. Otherwise, the components of FIG. 6 are identical to those of FIG. 3.

We claim:

1. A circuit comprising a signal source, said signal source being other than an electret microphone and having a negative pole bearing a negative charge and a grounded pole connected to ground, a field effect transistor (“FET”) having a drain, a gate and a source, wherein the negative pole of the signal source is connected to the gate of the FET, a source of direct current electric power is connected to the drain of the FET and the source of the FET is connected to ground,
wherein the invention comprises:
a resistor connected between the drain and the source of the FET so as to reduce the drain to source voltage and reduce and linearize the sensitivity of the drain to source voltage in response to changes in the gate to source voltage.

2. The circuit of claim 1 wherein the resistor connected between the drain and source of the FET is a potentiometer of variable resistance.

3. The circuit of claim 1 wherein the signal source and the FET are mounted within an acoustically insulated mask, a headset, a phone or a personal digital assistant.

4. The circuit of claim 2 wherein the signal source and the FET are mounted within an acoustically insulated mask, a headset, a phone or a personal digital assistant.

5. A circuit comprising a signal source, said signal source being an audio signal source other than an electret microphone and having a negative pole bearing a negative charge and a grounded pole connected to ground, a field effect transistor (“FET”) having a drain, a gate and a source, wherein the negative pole of the electret is connected to the gate of the FET, a source of direct current electric power is connected to the drain of the FET, the source of the FET is connected to ground, isolating means are connected to the drain and source of the FET to generate a signal as the drain to source voltage with the DC bias removed, said signal being amplified by amplifying means, digitized by digitizing means and converted to text by speech recognition software,
wherein the invention comprises:
a resistor connected between the drain and the source of the FET so as to reduce the drain to source voltage and reduce and linearize the sensitivity of the drain to source voltage in response to changes in the gate to source voltage.

6. The circuit of claim 5 wherein the resistor connected between the drain and source of the FET is a potentiometer of variable resistance.

7. The circuit of claim 5 wherein the signal source and the FET are mounted within an acoustically insulated mask, a headset, a phone or a personal digital assistant.

8. The circuit of claim 6 wherein the signal source and the FET are mounted within an acoustically insulated mask, a headset, a phone or a personal digital assistant.

9. A method of using a resistor in a circuit, said circuit comprising a signal source, said signal source being other than an electret microphone and having a negative pole bearing a negative charge and a grounded pole connected to ground, a field effect transistor (“FET”) having a drain, a gate and a source, wherein the negative pole of the signal source is connected to the gate of the FET, a source of direct current electric power is connected to the drain of the FET and the source of the FET is connected to ground,
wherein the invention comprises:
connecting the resistor between the drain and the source of the FET so as to reduce the drain to source voltage and reduce and linearize the sensitivity of the drain to source voltage in response to changes in the gate to source voltage.
